(19) United States
(12) Patent Application Publication
(10) Pub. No.: US 2002/0099503 A1
(43) Pub. Date: Jul. 25, 2002

(54) Theft prevention using location determination

(76) Inventors: Animesh Mishra, Milpitas, CA (US); Jun Shi, San Jose, CA (US); Harshad Junnarkar, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/765,823

(22) Filed: Jan. 19, 2001

(51) Int. Cl. B60R 25/00; G01C 21/34

(52) U.S. Cl. 701/213; 307/10.2

(57) ABSTRACT

An appliance determines its location, and may determine whether it has moved a distance or to a location which does not meet a local policy guideline. It may notify a central agency of such move, and the central agency may determine whether the move does not meet a remote policy guideline. The central agency may notify law enforcement. The appliance or the central agency may require a re-authentication of the user, and may disable the appliance.

### BACKGROUND OF THE INVENTION

1. Technical Field of the Invention

The present invention relates generally to preventing theft of devices.

2. Background Art

Location determination and motion detection devices are known, including such mechanisms as mercury switches, accelerometers, and global positioning system (GPS) devices. It is known to utilize such devices in a passive, queried mode to provide theft deterrence. For example, automobiles equipped with the OnStar System can be remotely disabled after the theft has been detected. However, this requires that the owner or other person notice that the automobile has been stolen.

Furthermore, if the thief disables the OnStar System before the owner phones in a report of the theft, the OnStar personnel will be unable to disable the vehicle remotely.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 illustrates one embodiment of a system which utilizes the principles of this invention, including an exemplary appliance device to be protected against theft.

FIG. 2 illustrates one embodiment of a method of operating the device to be protected against theft.

FIG. 3 illustrates another embodiment of a method of operating the device to be protected.

### DETAILED DESCRIPTION

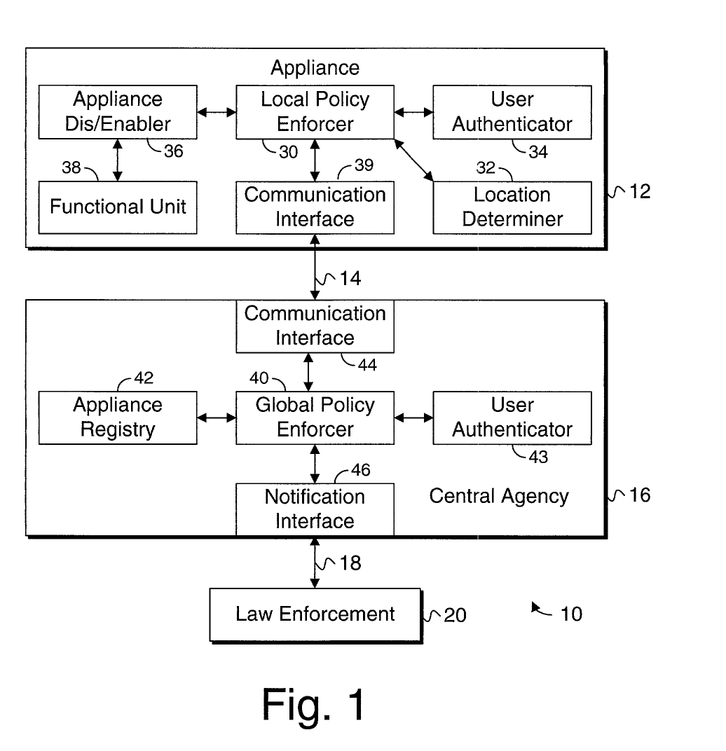

FIG. 1 illustrates a system 10 according to this invention, including an exemplary device 12 to be protected against theft. For simplicity, the device 12 will be referred to as an appliance, but the reader will understand that it may be any type of device whatsoever, such as an automobile, a home appliance such as a refrigerator, a computer, or a television.

The appliance is coupled over a communication link to a central agency 16 service or device which may, in turn, be coupled over a notification link 18 to a law enforcement agency device 20 such as a central dispatch computer, radio, or the like. The reader will appreciate that the communication link and the notification link may utilize a telephone network, computer network, the internet, wireless, cellular, satellite, laser, audio, or any other suitable mechanism.

The appliance includes a local policy enforcer 30, a location determiner 32 which may be a location determination device or a motion detection device, a user authenticator 34, an appliance disabler/enabler, a functional unit 38, and a communication interface 39.

The local policy enforcer may constitute a software-programmed microprocessor, hard-wired logic, or other suitable means of performing the functionality of the local policy enforcer, which will be described below.

The location determiner may be as simplistic as a mercury switch, which detects only motion but not relative position much less absolute position; or it may be a more complex device such as a GPS receiver, which detects absolute position as well as motion; or it may be something in between such as an accelerometer, which detects motion and relative position but not absolute position.

The user authenticator may be as simple as a key device which may readily be possessed by any user; or it may be as complex as a biometric identity analyzer which is specific to a single individual user; or it may be something in between such as a password system. It may include simply a data gathering mechanism, but it may also include means for applying policies or comparing the data against, for example, a locally-stored copy of known-valid data, such as from a previously sampled user input.

The enabler/disabler is adapted for enabling and/or disabling the functional unit. In some embodiments, the functional unit may be in a default state of disablement until the enabler/disabler enables it. In other embodiments, the functional unit may be enabled unless the enabler/disabler disables it.

The functional unit provides the functionality of the appliance and would typically be found in an appliance which lacks the features of this invention; for example, in the case of a television, the functional unit might be the tuner or the display or the on/off switch.

The appliance's communication interface is suitably adapted for communicating over the chosen communication link. In one embodiment, the location determiner and user authenticator may be coupled to the local policy enforcer, and the local policy enforcer may be coupled to the communication interface. Other configurations will, of course, be apparent given the teachings of this patent.

The central agency service or device 16 includes a communication interface 44 which is suitably adapted for communicating with the appliance over the communication link. It further includes a remote policy enforcer 40, an appliance registry 42, an optional user authenticator 43, and an optional notification interface 46. The remote policy enforcer may constitute a software-programmed microprocessor, hard-wired logic, or other suitable means of performing the functionality of the remote policy enforcer, which will be described below. The appliance registry may include a database or other suitable data storage and retrieval system, and a storage device for housing the database, such as a hard disk, a tape drive, a DVD-R drive, semiconductor memory, or other suitable storage means. The user authenticator 43 will not typically include a user data input gathering device, such as the biometric apparatus or password input means of the user authenticator 34 of the appliance. The central agency's user authenticator 43 may gather data through such user data input gathering device, and apply locally-held knowledge or policies, such as by comparing the user's biometric information against a stored database (not shown). The notification interface is suitably adapted for communicating over the chosen notification link.

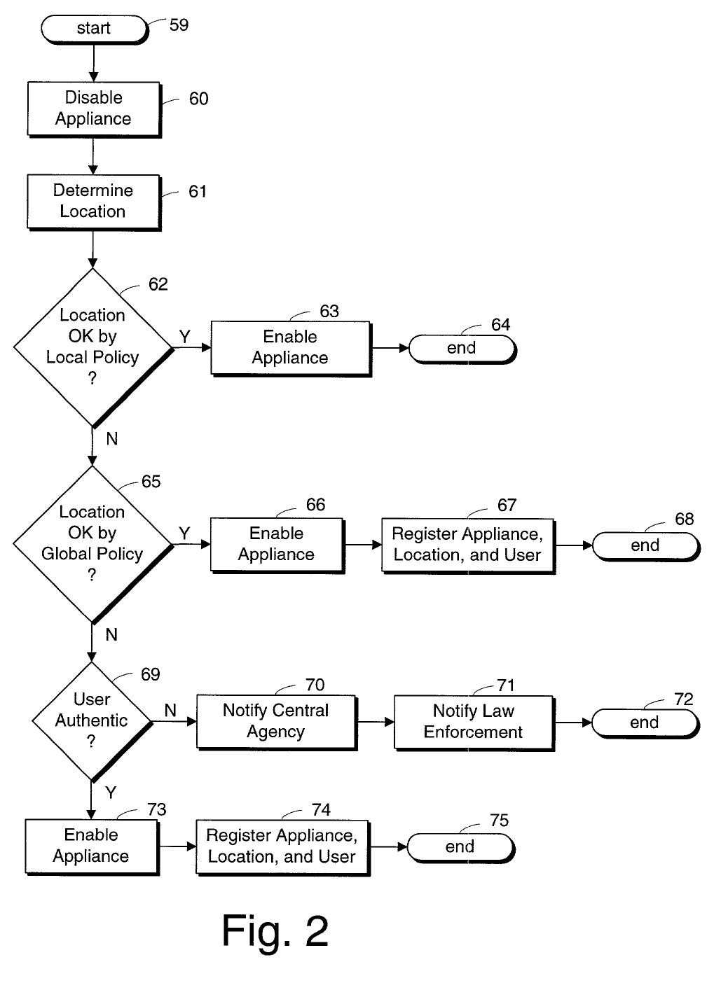

FIG. 2 shows a flowchart which illustrates one exemplary embodiment of a method of operating the appliance of FIG. 1, to which the reader is also referred. FIG. 2 should also be understood to represent one or more information storage devices having stored thereon instructions, operations, routines, control codes, or the like, which, when loaded into or executed upon a programmed computer device, a programmable logic device, or the like, will cause such device to execute the exemplary method.

The method begins (59) with the appliance being disabled (60). The appliance determines (61), via its location determiner, where the appliance is presently located. In the simplistic case of e.g. a mercury switch, what is determined is simply that the appliance has moved, rather than an absolute or relative position.

Then, the local policy enforcer checks (62) whether that location meets guidelines of a local policy. A variety of local policies may be utilized in practicing this invention. Examples, given by way of illustration and not exhaustive enumeration, include:

no motion

motion over short enough distance that the appliance is likely to still be within the user's house

previously approved location

If the location meets the local policy, then the local policy enforcer enables (63) the appliance. In various embodiments, this may constitute providing power to the functional unit. In other embodiments, it may constitute unlocking the functional unit. The reader will appreciate that a suitable dis/enablement mechanism may readily be chosen for a given appliance, given the teachings of this patent. The reader will also appreciate that various mechanisms may be adapted to disable the appliance, to enable the appliance, or to do both; thus the term “dis/enablement”. Once the appliance is enabled, the method may end (64) until a next time that, for example, it is powered on, or a next time that it is moved.

If the location does not meet the local policy, then the appliance will communicate information over the communication interface and communication link to the central agency. In various embodiments, the information sent to the central agency may be, for example, the location of the appliance, the fact that the appliance has moved, an indication of in what manner the local policy was failed, a unique identification of the appliance, an identification of the owner of the appliance, a most recent location which did not fail the local policy, or any combination of such information or other suitable information.

The central agency's remote policy enforcer will make a determination (65) of whether the new location (or other submitted data) meets a remote policy. A variety of remote policies may be utilized in practicing this invention, such as, for example:

motion over a short enough distance that theft is unlikely

motion to a pre-approved location such as a repair facility

motion to a new location authorized by the owner pursuant to a sale of the appliance

Nth instance of motion where N is less than a predetermined value

total motion during the lifetime of the appliance is less than a predetermined maximum, such as a prepaid rental mileage

motion to a location still within a country within which usage of the appliance is permitted by law

If the location meets the remote policy, the central agency remotely enables (66) the appliance. This may be done by sending an enablement signal or value back over the communication link, or by other suitable mechanism. In some instances, it may be desirable to have the appliance be self-enabling unless the central agency disables the appliance. Upon receipt at the communication interface of the dis/enablement signal, the local policy enforcer triggers the dis/enabler to enable or disable the functional unit.

In some embodiments, it may be desirable to update (67) the appliance registry with the new location or other information provided by the appliance or derived from such information. Once the appliance is enabled and the new information is registered, the method may end (68) until a next time it is utilized.

If the location failed the remote policy, in some embodiments the appliance may simply be disabled (not shown). In other embodiments, it may be more desirable to provide for a mechanism to allow the appliance to be used even though its movement has failed both the local and remote policies. One suitable choice is by authenticating (69) the user. This may involve the user inserting a key into the user authenticator, or the user entering a password into the user authenticator, or the user authenticator gathering biometric data about the user, such as via a thumbprint pad or an iris scan.

If the user is not authenticated, the appliance notifies (70) the central agency, which in turn may notify (71) law enforcement. In some embodiments, the authentication may be checked at the central agency rather than at the appliance; in this case, the appliance will not need to notify (70) the central agency. The central agency may provide to law enforcement any of the data which the central agency has about the user, the location and identity of the appliance, and so forth. In some embodiments, the user authenticator on the appliance may be simply a data input device (whether it be a key, a password, or a biometric input device), and the logic to determine whether the user is authentic may reside at the central agency. This would help prevent a thief from altering the output of the user authenticator, or sending back simplistic “he is authentic” types of messages. In such cases, the notification (70) to the central agency will be data to be used in a determination, rather than an outcome of a determination. The method may end (72) with the appliance being left in a disabled state, or in some embodiments, in an enabled state. In some cases, the functionality of the device (such as a defibrillator) is important enough that it is better to leave the device functioning in the hands of a possible thief. In some cases, it may be desirable to leave the device operational so that the thief is unaware that the theft has been noticed and reported to law enforcement. In some embodiments, the law enforcement notification may be done directly by the appliance, rather than, or in addition to, by the central agency.

If the user is authenticated, the appliance is enabled (73), the register is updated (74), and the method ends (75).

In some embodiments, the local policy and/or remote policy may have dynamically adjustable guidelines. Consider the example of a golf cart. The first time the golf cart is turned on, the policies may require a user authentication. Then, as long as the golf cart does not leave the general vicinity (meaning that it is likely to still be at the same golf course), no authentication may be required. Then, when the cart suddenly moves to a different course, authentication may again be required. But then, on a second or third trip to different courses, within the same city, authentication may not be required; the policies may learn that the legitimate user has recently changed his playing habits.

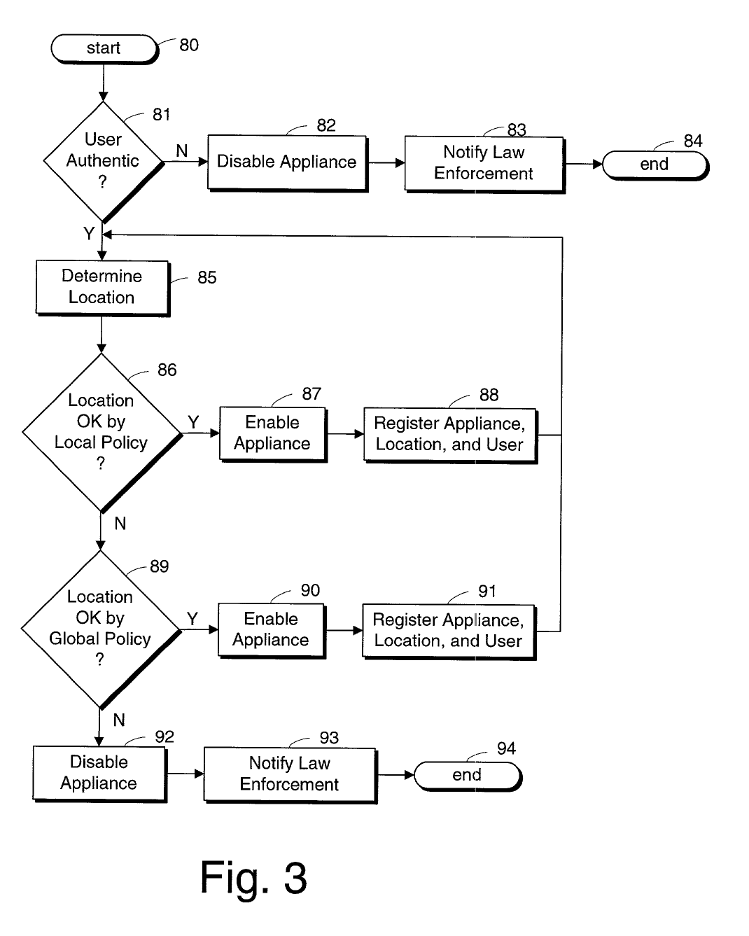

FIG. 3 illustrates another embodiment of a method for practicing the invention. The method begins (80) and the appliance attempts to authenticate (81) the user. If the user is not authenticated, the appliance is disabled (82), law enforcement is notified (83), and the method ends (84). If the user is authenticated, the location of the appliance is determined (84) if the location meets the local policy (86), the appliance is enabled (87) and the new location and so forth may optionally be registered (88), then the method returns to re-checking the location, providing continuous location policy checking. If the location fails the local guidelines, then it is checked against the global guidelines (89). If it meets the local guidelines, the appliance is enabled (90) and the new location and so forth may optionally be registered (91), and the method returns to re-checking the location continuously. If the remote policy is also failed, the appliance is disabled (92), law enforcement is notified (93), and the method ends (94). Alternatively, the method could disable the appliance at the start, so it would be disabled until one of the policies enables it.

The reader will appreciate that the signals or values transmitted over the communication link and notification link may advantageously be protected by suitable means, such as by data encryption. Use of a public key system over the communication link may be used to prevent a thief from stealing the appliance and leaving a dummy device behind in place of the appliance; the public key system will enable the central agency to authenticate that the appliance is what it claims to be.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The various elements of the appliance and/or central agency may be constructed in hardware, software, or a combination thereof. The phrase “device” is not necessarily limited to hardware devices, nor to discrete, stand-alone mechanisms.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus comprising:
a functional unit;
a location determination device;
a local policy enforcement device coupled to the location determination device and the functional unit; and
a communication interface coupled to the local policy enforcement device.

2. The apparatus of claim 1 wherein the location determination device comprises a position detection device.

3. The apparatus of claim 2 wherein the position determination device comprises a global positioning system receiver.

4. The apparatus of claim 2 wherein the position determination device comprises an accelerometer.

5. The apparatus of claim 1 wherein the location detection device comprises a motion detection device.

6. The apparatus of claim 1 further comprising:
a user authenticator coupled to the local policy enforcement device.

7. The apparatus of claim 6 wherein the user authenticator comprises a password device.

8. The apparatus of claim 6 wherein the user authenticator comprises a biometric input device.

9. The apparatus of claim 6 wherein the location determination device comprises a global positioning system receiver.

10. The apparatus of claim 6 wherein the location determination device comprises an accelerometer.

11. The apparatus of claim 1 wherein the local policy enforcement device comprises means for determining whether the apparatus is within a distance from a location.

12. The apparatus of claim 11 wherein the distance is a predetermined distance.

13. The apparatus of claim 11 wherein the location is a predetermined location.

14. The apparatus of claim 11 wherein the location is a previously-determined location of the apparatus.

15. The apparatus of claim 14 wherein the distance is a predetermined distance.

16. The apparatus of claim 1 wherein the local policy enforcement device comprises means for dynamically adapting a local policy in response to previous location determinations and previous applications of the local policy.

17. The apparatus of claim 1 wherein the local policy enforcement device comprises means for determining, in response to a determination by the location determination device that the apparatus has been moved to a new location, whether the new location complies with a local policy.

18. The apparatus of claim 17 wherein the local policy is whether the new location is a pre-approved location.

19. The apparatus of claim 17 wherein the local policy is whether the new location is within a distance from a prior location of the apparatus.

20. The apparatus of claim 19 wherein the distance is a predetermined distance.

21. A method of operating an apparatus, the method comprising:
determining a location of the apparatus;
checking whether the location complies with a local policy determined by the apparatus;
if the location complies with the local policy, enabling operation of the apparatus; and
if the location does not comply with the local policy, disabling operation of the apparatus.

22. The method of claim 21 further comprising, if the location does not comply with the local policy:
performing an authentication of a user of the apparatus;
if the user is authenticated, enabling operation of the apparatus; and
if the user is not authenticated, disabling operation of the apparatus.

23. The method of claim 22 further comprising:
communicating to an external agent.

24. The method of claim 23 wherein the communicating comprises providing an indication of the location of the apparatus.

25. The method of claim 24 wherein the communicating further comprises providing data gathered during the authentication of the user.

26. The method of claim 25 wherein the data comprises biometric input data.

27. The method of claim 21 wherein the local policy is whether the location of the apparatus is within a predetermined area.

28. The method of claim 21 wherein the local policy is whether the location of the apparatus is less than a predetermined distance from a prior location.

29. The method of claim 21 wherein the local policy is whether the location of the apparatus is a pre-approved location.

30. The method of claim 21 further comprising:
dynamically adjusting the local policy.

31. A method of operating an apparatus, the method comprising:
(A) performing authentication of an attempted user of the apparatus;
(B) if the user is determined to be not authorized to use the apparatus,
(B.1) disabling the apparatus; and
(C) if the user is determined to be authorized to use the apparatus,
(C.1) determining a location of the apparatus,
(C.2) checking whether the location complies with a local policy administered by the apparatus,
(C.3) if the location complies with the local policy,
(C.3.a) enabling the apparatus, and
(C.4) if the location does not comply with the local policy,
(C.4.a) inquiring of an external agent whether the location complies with a remote policy administered by the external agent,
(C.4.b) if the location complies with the remote policy,
(C.4.b.1) enabling the apparatus, and
(C.4.c) if the location does not comply with the remote policy,
(C.4.c.1) disabling the apparatus.

32. The method of claim 31 further comprising:
(B.2) the remote agent providing an electronic notification to a law enforcement device; and
(C.4.c.2) the remote agent providing an electronic notification to the law enforcement device;
wherein the notifications to the law enforcement device include providing data identifying the location of the apparatus.

33. The method of claim 32 wherein the notifications to the law enforcement device further include providing data gathered during the authentication of the user.

34. The method of claim 33 wherein the data comprises biometric input data.

35. The method of claim 31 further comprising:
(C.4.b.2) the remote agent registering the location of the apparatus.

36. The method of claim 31 wherein the local policy comprises determining whether the location is in compliance with a policy selected from the group comprising:
the location of the apparatus is within a predetermined area;
the location of the apparatus is less than a predetermined distance from a prior location; and
the location of the apparatus is a pre-approved location.

37. The method of claim 31 wherein the local policy comprises determining whether the location is in compliance with a distance-based policy.

38. The method of claim 31 wherein the local policy comprises determining whether the location is in compliance with an area-based policy.

39. The method of claim 31 wherein the remote policy comprises determining whether the location is in compliance with a policy selected from the group comprising:
the location of the apparatus is within a predetermined area;
the location of the apparatus is less than a predetermined distance from a prior location;
the location has been pre-approved by a registered owner of the apparatus;
the location is an authorized repair facility for the apparatus;
all locations have been pre-approved until a first registration at a first location;
total motion of the apparatus since a predetermined time is less than a predetermined cumulative distance;
the apparatus has been moved fewer times than a predetermined number; and
the apparatus is within a non-export-controlled country;.

40. The method of claim 31 further comprising at least one of:
dynamically adjusting the local policy; and
dynamically adjusting the remote policy.

41. A system comprising:
a communication link
an appliance including,
a functional unit;
means for dis/enabling the functional unit;
a location determination device;
a local policy enforcement device coupled to the communication link, to the means for dis/enabling, and to the location determination device; and
a remote agent device including,
a registry adapted to store information regarding the apparatus; and
a remote policy enforcement device coupled to the communication link and to the registry.

42. The system of claim 41 wherein the information includes location information.

43. The system of claim 42 wherein the appliance further includes a user authentication device coupled to the local policy enforcement device.

44. The system of claim 43 wherein the information further includes user identification information.

45. The system of claim 41 wherein the location determination device comprises a global positioning system receiver.

46. The system of claim 41 wherein the location determination device comprises an accelerometer.

47. The system of claim 41 wherein the local policy enforcement device comprises means for determining whether the appliance is in a location, determined by the location determination device, which location complies with a policy selected from the group comprising:
the location of the appliance is within a predetermined area;
the location of the appliance is less than a predetermined distance from a prior location; and
the location of the appliance is a pre-approved location.

48. The system of claim 47 wherein the remote policy enforcement device comprises means for determining whether the location complies with a policy selected from the group comprising:
the location of the appliance is within a predetermined area;
the location of the appliance is less than a predetermined distance from a prior location;
the location has been pre-approved by a registered owner of the appliance;
the location is an authorized repair facility for the appliance;
all locations have been pre-approved until a first registration at a first location;
total motion of the appliance since a predetermined time is less than a predetermined cumulative distance;
the appliance has been moved fewer times than a predetermined number; and
the appliance is within a permitted country.

49. The system of claim 41 further comprising:
means for dynamically adjusting a local policy of the local policy enforcement device.

50. The system of claim 41 further comprising:
means for dynamically adjusting a remote policy of the remote policy enforcement device.

51. A method comprising:
an apparatus determining its location;
the apparatus determining whether the location complies with a local policy;
the location complies with the local policy,
enabling the apparatus;
if the location does not comply with the local policy,
a remote device determining whether the location complies with a remote policy;
if the location complies with the remote policy,
enabling the apparatus,
if the location does not comply with the remote policy,
disabling the apparatus.

52. The method of claim 51 further comprising, if the location does not comply with the remote policy:
performing authentication of a user of the apparatus; and
if the user is authenticated,
enabling the apparatus.

53. The method of claim 52 further comprising, if the location complies with the remote policy:
the remote device registering information provided from the apparatus to the remote device.

54. The method of claim 53 wherein the information comprises information identifying the location.

55. The method of claim 52 further comprising, if the user is not authenticated:
the remote device sending a notification to a law enforcement device.

56. The method of claim 55 wherein the notification comprises an identification of the location of the apparatus.

57. The method of claim 56 wherein the notification further comprises information gathered during the authentication of the user.

58. The method of claim 57 wherein the information comprises biometric input data.

59. The method of claim 51 further comprising:
the apparatus dynamically adjusting the local policy.

60. The method of claim 59 further comprising:
the remote device dynamically adjusting the remote policy.

61. In an apparatus which includes a functional unit, an improvement comprising:
means for disabling the functional unit;
means for identifying a location of the apparatus;
means for checking the location against a local policy, and for causing the means for disabling to enable the functional unit if the location complies with the local policy and for causing the means for disabling to disable the functional unit if the location does not comply with the local policy.

62. In the apparatus of claim 61, the improvement further comprising:
means for authenticating a user of the apparatus; and
the means for checking further for causing the means for disabling to enable the functional unit if the user is authentic, and for causing the means for disabling to disable the functional unit if the user is not authentic.

63. In the apparatus of claim 61 for use with a remote agent which checks the location against a remote policy, the improvement further comprising:
means for communicating with the remote agent; and
the means for checking further for causing the means for disabling to enable the functional unit if the remote agent indicates that the location complies with the remote policy, and for causing the means for disabling to disable the functional unit if the remote agent indicates that the location does not comply with the remote policy.

64. In the apparatus of claim 63, the improvement further comprising:
means for authenticating a user of the apparatus; and
the means for checking further for causing the means for disabling to enable the functional unit if the user is authentic, and for causing the means for disabling to disable the functional unit if the user is not authentic.
